(19) United States
(12) Patent Application Publication
(10) Pub. No.: US 2013/0259067 A1
(43) Pub. Date: Oct. 3, 2013

(54) Method for Providing an MPLS Tunnel with Shared Bandwidth

(71) Applicant: ECI TELECOM LTD., Petach Tikva (IL)

(72) Inventor: Gideon AGMON, Kfar Saba (IL)

(73) Assignee: ECI TELECOM LTD., Petach Tikva (IL)

(21) Appl. No.: 13/845,517

(22) Filed: Mar. 18, 2013

(30) Foreign Application Priority Data
Mar. 27, 2012 (IL) 218899

(51) Int. Cl. H04L 12/24

(52) U.S. Cl. CPC H04L 41/0896
USPC 370/468

(57) ABSTRACT

A method is described for providing an MPLS tunnel adapted for sharing bandwidth (BW) in an MPLS network. The method comprises establishing the MPLS tunnel as a working MPLS tunnel (ST) to be shared by a plurality of pseudo wires (PWs) passing at least partially along the path of the tunnel ST, wherein a predetermined bandwidth of the bandwidth allocated for the ST is adapted to be shared by the plurality of PWs, of which at least one PW has a different source point and/or a different destination termination point at the ST path, from at least one other of the plurality of PWs.

### TECHNICAL FIELD

The present invention belongs to the field of conveying MPLS traffic, more specifically to establishing and to protecting MPLS traffic at the level of MPLS tunnels, and to a suitable MPLS network. In particular, the invention relates to optimization of bandwidth allocation and addresses tunnel scalability in large MPLS networks.

### BACKGROUND

In order to explain the relevant state of the art, the following specific terms should be clarified, which relate to traffic arrangement (traffic establishing and traffic protection) in MPLS networks:

MPLS Tunnel (tunnel)—is a Label Switched Path (LSP), being a lower layer which can be used for establishing and for protecting traffic in MPLS network. Traffic protection within a tunnel (at the tunnel level, such as Fast ReRoute protection, “FRR”), has a relatively low cost;
Pseudo wire (PW)—a connection between two specific points in an MPLS network for a specific service. A single service may need more than one PWs, since it needs more than one connections between different Source and Destination points (say, a point to multi-point “PTMP” service; another case is a multipoint-to-multipoint service MP2MP). Protection at the level of PWs, (and even protection of tunnels by arranging a new PW, as will be shown below in FIG. 2) costs more than a pure tunnel level protection.
E-TREE (point to multipoint services) and E-LAN (multipoint to multipoint services) are terms that are defined by MEF: “Ethernet Services Definitions, Phase 2-MEF 6.1”

The following MPLS network problems are well known to those skilled in the art and will be addressed by the present invention:
Excessive bandwidth allocation when establishing tunnels for the provisioning of E-LAN and E-TREE services. Bandwidth is usually allocated per tunnel (and not per service for all the tunnels which are used for providing the service).
Large numbers of tunnels, especially for large networks characterized by a so-called “full mesh” configuration required for providing E-LAN service.
FIGS. 1A and 1B (prior art) illustrate the network size required for a communication service such as an E-Tree service, in Ethernet and MPLS networks, respectively. A ring topology is used just as an example.

FIG. 1A is a schematic illustration of a ring having a size=1 (from bandwidth perspective, i.e. 1 BW unit), for an Ethernet service carrying traffic of 1 BW unit. For protection of the service in the opposite direction within the ring, another BW unit would be required.

FIG. 1B is a schematic illustration of a point-to multipoint (such as E-tree) MPLS service having a common root (Source) node and three different leaf (destination) nodes in a ring-like network. One root-leaf pseudo wire PW utilizes a predetermined BW required for the service. Each one of the PWs utilizes the predetermined PW, so that the total BW required is BWx3. The root may communicate with either of the leaves at any given time, so it must have a dedicated PW to each of the leaves). For the PIMP (e-tree) service three illustrated tunnels and three respective PWs are required, and three-fold BW would therefore be needed. Thus, the Ring has size=3, 5 and if the MPLS FRR protection for each of the tunnels is also counted, we would get a ring of a size=6).

When considering the prior art described with reference to FIGS. 1A and 1B, the excessive BW allocation can be addressed, to some extent, by a complex CAC (Call Admission Control), in cases where one can guarantee that the real traffic bandwidth may actually be shared between tunnels (FIG. 1B). Yet,
It relies on prior knowledge of the traffic pattern and CAC, rather than on enforcing by traffic management; and
Many tunnels are still required (FIG. 1B).

Furthermore, when considering the prior art described with reference to FIG. 1B, the Inventor has noted that many tunnels are required for non-PTP services, for example P2MP services such as E-TREE (three tunnels in the above example), or E-LAN where full mesh is required between nodes.

In the above example of E-TREE service, BW is allocated for each of the 3 tunnels, although in many applications of E-TREE, only a single tunnel is active at a time.

FIG. 2 illustrates another known prior art scheme to address the above-mentioned problems: it shows an MS-PW (Multi-Segment Pseudo-Wire) described in IETF RFC 5659. (RFC 5659—http://tools.ietf.org/html/rfc5659 “An architecture for Multi-Segment PW Emulation Edge-To_Edge”).

For a network management entity such as NMS for the E-tree service traffic, as illustrated in FIG. 1B, three tunnels T1, T2, T3 in the form of short (segment) tunnels between nodes (provider edges or elements PEs) PE0, PE1, PE2 and PE3, are required. (MS-PW is a Multisegment PW). Assuming that some tunnel-level protection is used (such as FRR or tunnel end-to-end protection in each segment tunnel), this MS-PW scheme has the significant drawback that on failure, such as PE#1 failure, traffic between PE#0 and PE#2 or PE#3 fails and cannot be protected by protecting the tunnel from PE#0 and PE#1, thus requiring a higher level (PW level) of protection, such as PW-redundancy or dual homing. In other words, recovering from PE failures would require some dual homing scheme, like PW-Redundancy, but this again would imply that more tunnels and more BW are required.

Yet another prior art solution to be referred herein is a so-called “LSP Stitching” described for example in RFC 5150 (LSP Stitching with GMPLS TE; RFC 5150—http://tools.ietf.org/html/rfc5150—LSP Stitching with GMPLS-TE), but because the stitched LSP cannot add or drop traffic between its segments, the limitations as described above for MS-PW, still apply.

### OBJECT AND SUMMARY OF THE DISCLOSURE

One of the main purposes of the present invention is to provide an improved, new MPLS tunneling scheme. The practical object is to provide a so-called Shared MPLS tunnel which would be most advantageous for provisioning and further processing and protecting of non-uniform working traffic services, and also where some budgeted/limited BW is ensured for clients:
a) for example, an E-Tree service (Point-to-Multipoint) using Hub and spoke topology, where the Hub serves a number of spokes simultaneously or intermittently, but requires a pre-determined aggregated BW;
b) E-LAN service (Multipoint-to-Multipoint) using for example a ring topology, where one node sends/receives a number of traffic flows to/from a number of other nodes over a shared link (e.g. ring topology) where the BW should be and is usually limited for the whole bunch of PWs (rather than per each PW between each node pair).

In such cases it is very uncomfortable/unsuitable to implement the known prior art arrangements of:

FIG. 1B arrangement—since it requires, for example, 3xBW for a single E-tree service comprising three working tunnels and respective pseudo wires;

FIG. 2 arrangement—which uses segment tunnels, allows ADD/DROP of traffic at nodes between the segments.

However, it cannot allow traffic protection at the level of tunnel, in case of failure of one of the PEs—and it needs to provide a new pseudo wire (PW) for protection of the traffic, via the remaining portion of the ring, thus rendering the arrangement to be a non-optimal solution.

The present invention on the other hand is concerned with allowing/teaching NMS (or a signaling system implemented between network nodes, or any other managing entity as the case may be) to establish, and configure network nodes to support a so-called Shared MPLS tunnel ST (i.e., shareable among a number of PWs along the tunnel path), which tunnel is integral and thus protectable by a regular FRR protection scheme, though allows adding and dropping of the traffic services using these PWs at one or more intermediate point(s) of the ST.

In other words, the ST tunnel of a number of PWs should preferably have:
a) Capability to ADD/DROP traffic in the middle of the shared tunnel ST, i.e. to have functions similar to an assembly of a number of “tunnel sections” connected in series, allowing ADD/DROP of traffic at points/nodes where the “tunnel sections” are joined;
b) Properties of an integral (though shared) tunnel, being protectable by FRR or other traffic protection technique at the tunnel level.

To the best of the Applicant's knowledge, nobody in the prior art solutions had tried to set a task to create/use one integral shareable MPLS tunnel (ST) for a number of working services (pseudo wires PWs) that do not originate and terminate at the same nodes, for example PWs of MP2MP or P2MP services. More particularly, there was no shared tunnel used for a service or number of services, (E-tree (PtMP) or E-LAN (MPtoMP) services) where each service has several pseudowires (PWs) that do not originate and terminate at the same nodes.

Further, nobody has established such an integral (i.e. single, non interrupted) shareable MPLS tunnel ST, which would be identified by a corresponding single label, would allow sharing its (ST's) predetermined BW by a number of PWs having different adds/drops in the middle of the tunnel ST.

Yet further, nobody has suggested that the protection on the level of MPLS tunnel can be reached for all the traffic services carried over such a working shared MPLS tunnel ST.

The newly proposed method may be defined according to the following.

In accordance with a first aspect, there is provided a method for providing an MPLS tunnel for sharing bandwidth (BW) in an MPLS network, the method comprises establishing said MPLS tunnel as an MPLS working tunnel (shared tunnel, “ST”) common for a plurality of pseudo wires (PWs) passing along the tunnel ST path, wherein a predetermined part of the bandwidth (BW) allocated for the ST is adapted to be shared by said plurality of PWs of which at least one PW has a different source point and/or a different destination termination point at the ST path, from at least one other of the plurality of PWs

One option of implementing the method described above, comprises associating the PWs with so-called sub-tunnels of the ST, wherein each of the sub-tunnels utilizes parameters of the ST (e.g. at least BW and label), but has a source point and/or a destination point that do not coincide with those of the ST. However, a PW and the proposed sub-tunnel with which the PW is associated will have the same source and destination points, as required when associating a regular PW with a regular tunnel.

One sub-tunnel may be associated with a number of PWs having common source and destination points. In other words, the method may comprise provisioning at least one sub-tunnel within said ST, and associating the at least one sub-tunnel with one or more of the PWs; the at least one sub-tunnel having the same source and destination points as its associated one or more PWs, which do not coincide with those of the ST, and utilizes at least bandwidth BW and label of the respective ST.

In practice, the method may comprise provisioning more than one sub-tunnels and associating some of the PWs with the sub-tunnels, and some of them with the ST.

The method may further comprise a step of protecting the traffic services carried over the working MPLS tunnel ST, in case of a failure of an element or link along the ST path, by provisioning a set of bypass MPLS tunnels for the working MPLS tunnel ST, say while implementing FRR technique. When creating the set of bypass MPLS tunnels, the sub-tunnels of the ST become inherently protected by the created ST bypass tunnels. Actually, if both the node and the link protection are required simultaneously, the bypass (protection) MPLS tunnels may be provisioned per sub-tunnel of the ST.

The invention thus proposes using the Shared-Tunnel ST to connect between all nodes used by services carried over the ST along the sub-tunnels. It may be applicable for P2MP, MP2MP topologies (used for E-TREE or E-LAN respectively), as well as for other services. The plurality of PWs may be provided for E-tree and/or E-LAN based traffic services.

The proposed ST spans across all nodes that have to add/drop traffic to/from it. Naturally, the ST tunnel may be just cross-connected in transit nodes, for example intermediate nodes at which no add/drop is required for a specific sub-tunnel/PW, so that this sub-tunnel/PW is cross-connected/passed through such a transit node. In case that the ST path comprises the three nodes as shown in the example, the sub-tunnel is not actually needed, as it is identical to the tunnel.

It will be further demonstrated in the detailed description, that the proposed concept allows survival of MPLS traffic at the tunnel level when one of PEs in the tunnel fails. An example of a failed node may be an intermediate node such as PE1 which is shown in FIGS. 1B and 2 for prior art arrangements, or PE#2 in FIG. 6 or 7 for the currently proposed arrangements. Since we use a shared non-interrupted working tunnel ST, this tunnel spans all the elements of the tunnel (from P#0 to PE#3), so that any of its segments may be protected by using tunnel level protection, for example FRR.

To implement the proposed concept, an NMS (or any other managing entity such as an EMS, a signaling system or the like, as mentioned above) should first configure the proposed shared MPLS tunnel ST, while the data plane (i.e., hardware/software configuration and processing in the network nodes, which is responsible for checking/switching MPLS labels, etc.) should support the configured tunnel.

The data plane should be understood as a plurality of functions performed on the transmitted data by hardware/software control means embedded in network nodes, the functions comprising checking/switching/swapping MPLS labels of tunnel and PWs, cross-connecting of data flows of specific PWs at a particular node to perform adding, dropping or just transparent conveyance of data flows.

The idea formulated above can be implemented by using NMS and by correspondingly configuring the network nodes; specific details of providing and switching of MPLS labels in this case will be further described in the detailed description that follows.

Alternatively, the proposed method may be implemented by using a signaling system.

In one version of the invention, the network is a ring network.

More specifically, the method preferably comprises:

provisioning common working MPLS tunnel ST, having an ST Tunnel ID and the predetermined allocated bandwidth BW, along a path extending between a Source node and a Destination node via an Intermediate node in the MPLS network, traffic of the ST carrying a specific ST label at each specific point of the ST path;

provisioning the two or more pseudo wires (PWs) for P2MP or MP2MP traffic services within the ST, so that at least one of the PWs is either started or terminated at the Intermediate node of the ST,

for the two or more PWs, provisioning one or more sub-tunnels within the ST and associating the sub-tunnels with the PWs, so that each of the sub-tunnels has the same source and destination points as its associated one or more PWs, wherein at each specific point of the ST path the sub-tunnels inheriting parameters of the ST, wherein the inherited parameters include at least the label and the BW of the ST.

The method may further comprise establishing the traffic services over the provisioned two or more PWs within the MPLS tunnel ST, thereby allowing the traffic services of the PWs to share the predetermined BW of the ST.

As already mentioned, two or more PWs may use one and the same sub-tunnel, if they have the same source and destination points. Separate sub tunnels are needed and provisioned for different source/destination combinations.

The pseudo wires, PWs, in the Shared Tunnel, ST, are able to share the ST bandwidth (ST BW) since the sub-tunnels inherit/utilize the label, the BW, and the traffic control of the ST; the sub-tunnels preferably also inherit CoS and it allows the traffic control to take care of the PWs traffic like it is one common traffic.

As mentioned above, in case of a failure in the working MPLS tunnel ST, the method may further comprise a step of protecting the traffic services carried over the ST, by establishing a protective (bypass) MPLS tunnel for the working MPLS tunnel ST.

The method may be implemented as follows:

in a managing entity selected from a non-exhaustive list comprising NMS, EMS, signaling system, the following actions may be performed:
configuring the ST and the sub-tunnels within the ST for the plurality of PWs, and associating the plurality of PWs with the configured sub-tunnels;
configuring one or more tunnels in the MPLS networks for providing tunnel level protection of the ST;

at each intermediate node (PE) along the ST path (and preferably at each node of the ST path, or optionally at each node of the MPLS network), the following actions are performed:
configuring said ST, and said sub-tunnels at the node, by providing at said intermediate node a list of the sub-tunnels relevant for (present at) the intermediate node, and each of said sub-tunnels with an indication regarding presence of its head (source) or tail (destination) at that intermediate node;
processing traffic services carried by the ST tunnel, so as in case that:
for any of the sub-tunnels having a tail at the intermediate node, performing a check of PW labels and further terminating traffic of the PW having its destination point at the intermediate node;
for any of the sub-tunnels having a head at the intermediate node, allowing egress from the intermediate node of a new PW having its source point at the intermediate node;
for any of the sub-tunnels having no tail nor head at the intermediate node (transit sub-tunnel), performing at least cross-connection at the intermediate node of the PW associated with said sub-tunnel, preferably without processing PW labels.

The step of configuring the sub-tunnels comprises configuring at the network node, the PWs which are terminated at that node, keeping in mind that each specific PW is associated with the ST or its sub-tunnel having the same source and destination points (nodes, PEs) as the specific PW.

The step of configuring the sub-tunnels may also comprise configuring, at the network node, the PW(s) of sub-tunnel(s) which are just transit and thus—are cross-connected at the node (other sub-tunnels belonging to the same ST tunnel may be terminated/dropped).

The configuring of PWs may include PW labels swapping (similarly to that required in the MS-PW case). This may be required because typically PW labels are unique at a node level (PE level, i.e., its ingress) rather than at a network level. However, in case a central managing entity like NMS allocates the PW labels, the configuration of the PW cross-connecting is not necessary, since the NMS is able to allocate for PWs associated with ST tunnels, network-unique PW labels. In this case, a PW that is not terminated in a PE and that does not need PW label swapping—would not have to be configured at that node.

It should also be noted that when NMS allocates, for PWs, network unique PW labels (i.e., synchronizes the use of PWs in the network), a unique label allocated for a specific PW and carried over the working ST will be used by this PW also over the protective tunnel. When a PW is sent over the ST tunnel, and the ST tunnel is protected—implying, for example, an additional tunnel label for that protection/bypass tunnel—it should be understood that the PW using the ST is exactly the same as in the bypass tunnel, and practically is agnostic to the tunnel protection state, so it may preserve its PW label intact.

According to a second aspect of the invention, there is provided a management entity for use in an MPLS network, for managing MPLS traffic in the MPLS network, the management entity being capable of establishing a common MPLS working tunnel (ST) for more than one pseudo wires (PWs) along the tunnel ST path in the network, wherein the ST having a predetermined bandwidth (BW) shareable by a plurality of PWs, and wherein at least one of the plurality of PWs has different source point and/or destination termination point from at least one other PW from among the plurality of PWs, extending along the ST path.

According to a third aspect of the invention, there is provided an MPLS network node (for example, a switch device with a Network Processor) configured to support an MPLS working shared tunnel (ST) carrying traffic packets, established by a network managing entity in the network for a plurality of pseudo wires (PWs) commonly utilizing the tunnel ST path in that MPLS network and sharing a predetermined bandwidth (BW) of the ST; the MPLS network node being part of the ST path and being configured to ensure for one or more of said PWs source points and/or destination (termination) points which do not coincide with source and destination points of the ST, and to ensure suitable processing of the traffic packets (i.e., of the tunnel ST packets respectively encapsulating PW packets).

Also, there is provided an MPLS network with at least one tunnel (ST) established according to the method described above, the ST tunnel passing via one or more network elements/nodes configured to support the ST tunnel.

Further, there is finally provided a shared MPLS tunnel (ST) in an MPLS network, being characterized by sharing bandwidth BW thereof between a number of pseudo wires PWs utilizing the ST tunnel wherein at least one of the pseudo wires does not share the ST tunnel source point and/or destination point. A further distinctive feature of the proposed shared MPLS tunnel (ST) is in that a flow of tunnel packets of the ST comprises a group of tunnel packets respectively encapsulating packets of pseudo wire(s) having source and/or destination points not coinciding with those of said ST.

Preferably, the ST is adapted for E-TREE and/or E-LAN traffic services comprising different pseudo wires including those not completely coinciding with the ST by their source and/or destination points; the pseudo wires of the traffic services share bandwidth (BW) of the ST.

According to yet another aspect of the invention, there is provided a software product comprising computer implementable instructions and/or data for carrying out the method described above, stored on an appropriate computer readable storage medium so that the software is capable of enabling operations of said method when used in a computer system. The software product may be partially located in the managing entity (NMS, EMS) of the MPLS network, and partially in control units of the network nodes.

In practice, the data forwarding may be performed (alternatively or in cooperation with software) by a piece of specific hardware, like a network processor of a switching device, etc.

The invention will be further described in detail as the description progresses.

### BRIEF DESCRIPTION OF THE DRAWINGS

The present invention will be further described and illustrated with the aid of the following non-limiting drawings in which:

FIGS. 1A and 1B (prior art)—illustrate two known traffic arrangements in ring networks, for Ethernet and MPLS traffic, respectively;

FIG. 2 (prior art) illustrates a known arrangement for MPLS traffic in a ring network, comprising a number of separate tunnels between adjacent nodes, for forming a multi-segment pseudo-wire;

FIG. 3 illustrates a logical view of a proposed integral bidirectional shared tunnel ST, spanning all nodes in the path (from PE1 to PE3), where each unidirectional tunnel (ST#1, ST#2) has its unique Tunnel ID and also carries a specific label at each specific part of the path;

FIG. 4 illustrates a physical view of a proposed shared tunnel ST; as any regular MPLS tunnel, a unidirectional shared tunnel ST switches its label at a network node;

FIG. 5 illustrates an embodiment of logically applying the idea of sub-tunnels to unidirectional shared tunnels STs, so that each of the STs consist of several sub-tunnels marking the add/drop nodes; the unidirectional sub-tunnels preserve/inherit labels of their unidirectional tunnel ST;

FIG. 6 is a schematic illustration of a capability of the proposed ST to allow ADD/DROP of various traffic streams in the middle of the ST path;

FIG. 7 is an example of protection, at the tunnel level, for the proposed Shared Tunnel according to an embodiment of the present invention, wherein a set of bypass tunnels is built to protect each link or node along the ST tunnel path, as for a regular tunnel;

FIG. 8 is a schematic illustration of protocol layers of an MPLS communication network which allows better understanding of the concept proposed by the present invention; and

FIG. 9 is a schematic illustration of an exemplary way for configuring a shared tunnel ST and its sub-tunnels in a specific network node, according to an embodiment of the invention. The example is provided for an intermediate node PE#2 and for one direction (W-E) of traffic shown in FIG. 7.

### DETAILED DESCRIPTION

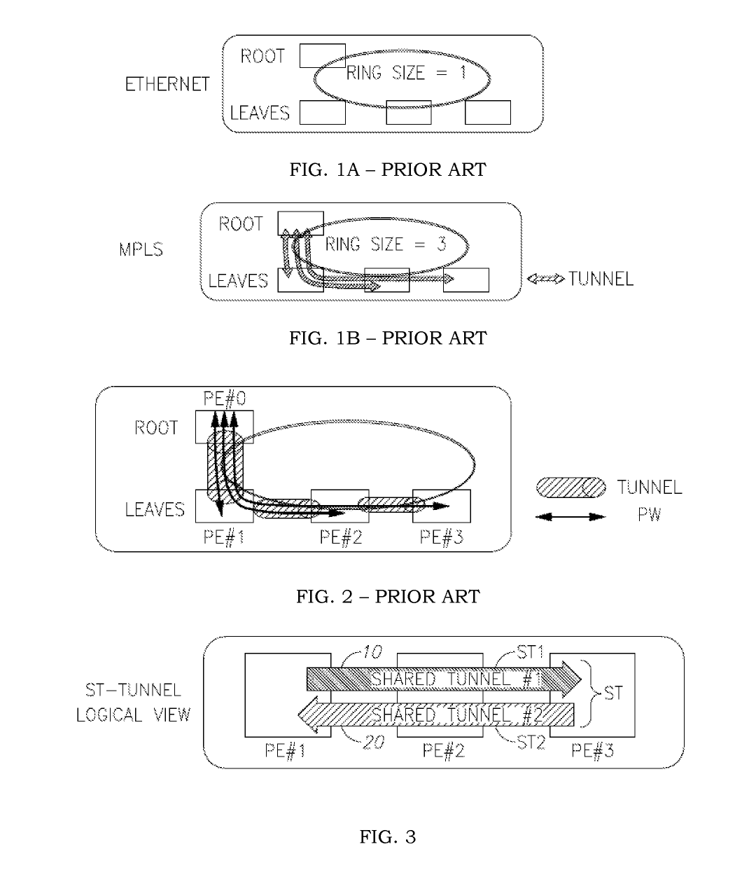

FIGS. 1 and 2 have been referred to in the Background section of the description.

The following figure (FIG. 3) shows an example of a shared tunnel ST across three PEs, namely, PE1, PE2 and PE3 (for bidirectional traffic two such tunnels are required). For simplicity of the description, we assume here that our discussed tunnels are unidirectional, although the ST-tunnel can be defined as a bidirectional tunnel. There are two STs for the two directions. The West-East tunnel 10 is marked as ST#1, while the East-West tunnel 20 is marked as ST#2. These numbers can be considered the ST tunnels' IDs.

FIG. 4 shows that physically, the proposed tunnel ST is composed of segments extending between network nodes (provider edges PEs): PE1, PE2 and PE3. The figure also shows the label switching in each intermediate PE in the ST path, which operation is regular for any MPLS tunnel.

As can be seen in FIG. 5, the shared tunnel ST is presented as formed by two sets of unidirectional “sub-tunnels” that actually allow selective add/drop of traffic in the middle of the ST path (from PE1 till PE3). Note that the label which is used by the ST at a specific span is used at that span for all “sub-tunnels” (belonging to the same unidirectional ST Tunnel). For example, LABEL 1 of the tunnel ST1 (10) is used by sub-tunnels 11, 13 of the tunnel 10 between PE1 and PE2. Label 2 of the tunnel ST1 is used by its sub-tunnels 12 and 13 between PE2 and PE3.

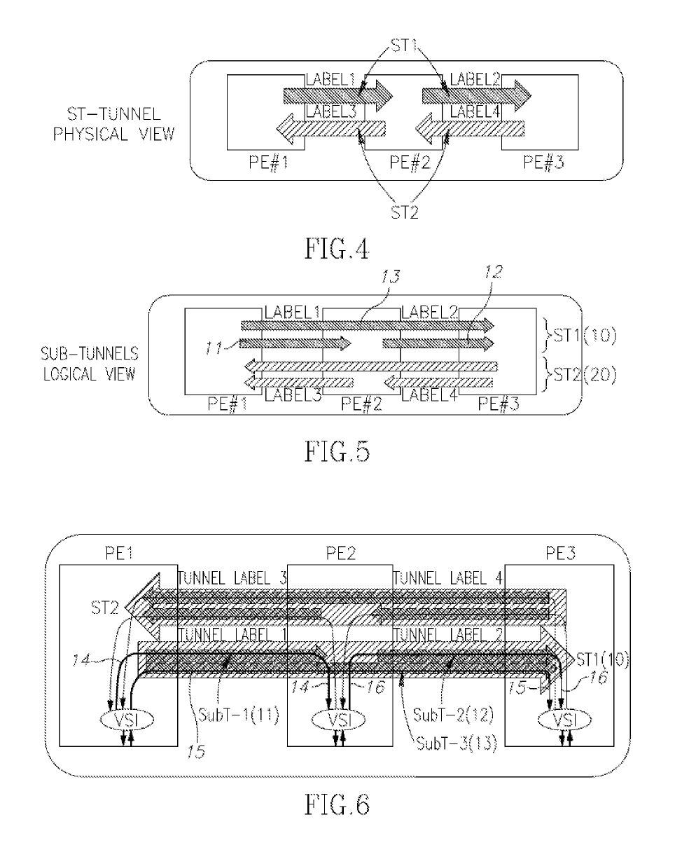

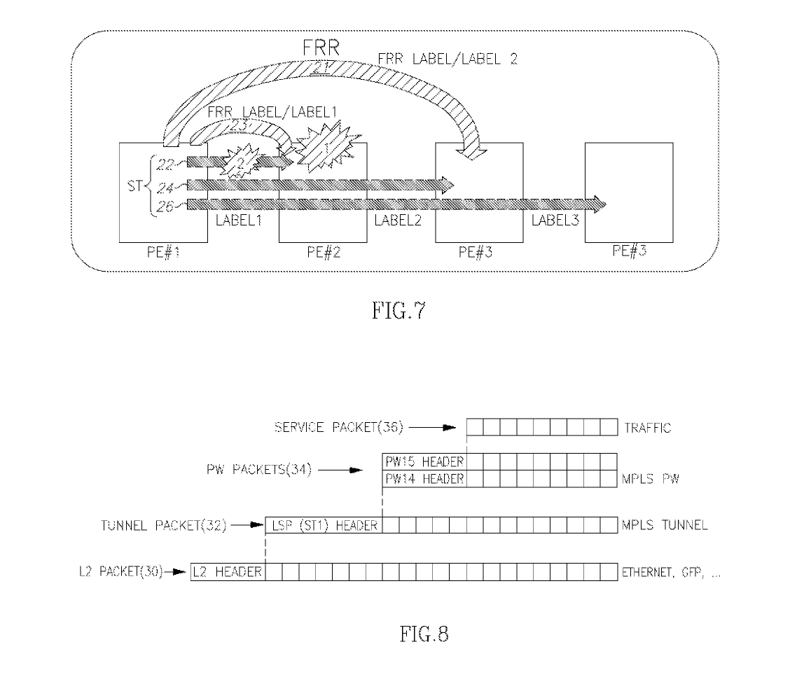

It should be noted that the sub-tunnel 13 of the shared tunnel 10 is shown in FIG. 5 (and in FIG. 6) just for the sake of illustration and explanation of the fact that sub-tunnels may have various source/head and tail/destination points within the parent tunnel. Actually, sub-tunnel 13 is equivalent to the parent tunnel 10 itself, and the same applies to the long sub-tunnel of tunnel 20.

The next figure, FIG. 6, illustrates one of the most important features of the proposed shared tunnel ST. As already has been discussed in the summary, the shared tunnel ST comprises (can be represented by, is formed of) sub-tunnels which have two main purposes/properties that will be further discussed below. FIG. 6 illustrates two unidirectional shared tunnels 10 and 20: ST1 and ST2. They are shown as two wide, oppositely directed arrows, each comprising narrower arrows which symbolize sub-tunnels of that specific ST. The first main purpose is to allow a novel property—adding/dropping traffic in the “middle” of the Shared Tunnel.

This novel property of the ST is shown in FIG. 6, which illustrates how various PWs (say, solid thick curved lines 14, 15 and 16), having source/add/head and destination/drop/tail termination points at various nodes of the illustrated path, are carried within a specific shared Tunnel ST (say, ST1 marked 10) by associating the PWs with sub-tunnels of the ST (SubT-1 marked 11, SubT-2 marked 12 and SubT-3 marked 13) and by utilizing these sub-tunnels for performing termination at the required nodes along the path ST1.

Since any LSP or tunnel (and our ST, too) is normally unidirectional, there are two STs 10 and 20 (ST1, ST2) in the figure, for the two traffic directions. Contrary to that, any pseudo wire PW is normally bidirectional. In FIG. 6, any bidirectional PW is shown as a pair of unidirectional PWs in the form of opposite curved arrows, one using ST1 and the other using ST2.

For the sake of simplicity, we shall consider only those PWs passing via ST1, but all the aspects of provisioning and processing apply mutatis mutandis to the PWs using ST2.

For example, PW 14 starting at node PE1 and having its destination point at PE2, terminates at PE2 using the sub-tunnel SubT1 (11). PW 15, starting at node PE1 and having its destination point at PE3, terminates at PE3 using the sub-tunnel SubT-3 (13) or the very ST tunnel ST1 (10). PW 16 starting at node PE2 and having its destination point at PE3, uses sub-tunnel SubT-2 (12) and terminates at PE3.

As discussed in FIG. 6, for each direction of traffic only one ST tunnel is illustrated with its BW (the thick arrows 10 and 20 spanning three PEs). Each unidirectional ST tunnel is composed of sub-tunnels sharing the BW of the ST and having termination points at intermediate PEs. In FIG. 6, based on the proposed sub-tunnels concept, each PW is associated with a sub-tunnel, so a PW carried by the Shared tunnel ST, can be defined by the source PE and the destination PE of its corresponding sub-tunnel. A PW in the prior art on the other hand, could be defined only for an MPLS tunnel, so that the head and tail of the PW always coincided with the source and destination points of the tunnel. In FIG. 2 (prior art), each PW was associated with an MPLS tunnel, i.e., with the tunnel's source point and the tunnel's destination point).

In other words, according to the invention, a PW is defined/established in a common shared tunnel (ST), but for a sub-tunnel having the label of the common ST though not necessarily having head and tail coinciding with those of the ST, so that the PW may terminate itself in the middle of the ST, with its sub-tunnel.

FIG. 6 illustrates two shared tunnels 10, 20 (thick arrows ST1 and ST2), that span across the three PEs. Each shared tunnel carries its tunnel label(s) (ST1 carries Label 1 between PE1 and PE2, and Label 2 between PE2 and PE3). Each shared tunnel contains Sub-tunnels (which are logical, virtual entities as described before). Note that the tunnel label is common to all sub tunnels that exit/enter the same tunnel, and at all—at each specific point of the ST tunnel. In both cases we have a single tunnel extending between neighbors (nodes in the network). As for regular MPLS tunnels, where tunnel label is switched at a node, a tunnel label is local and unique per node ingress.

It should be noted that though the PWs are preferably associated with the sub-tunnels (which is advantageous in cases of E-TREE or E-LAN services) but some of the PWs (for these or for other services) may be associated with the shared tunnel ST itself, if their heads and tails respectively coincide with the source and destination points of the ST.

Before describing the tunnel and PW processing in the nodes demonstrated of FIG. 6, let us first refer to FIGS. 8 and 9.

FIG. 8 illustrates schematically the fact that packets of different network protocols/levels have their headers/labels. In an MPLS network running over L2 protocol such as Ethernet, an L2 packet encapsulates an MPLS packet and has its L2 header (see the lowest, the longest packet 30 in FIG. 8).

At a higher level, an MPLS tunnel packet 32 is shown, which is provided with an LSP (tunnel) header. In the proposed embodiment of the invention, packet 32 is our ST tunnel packet. Let it be a packet of the ST1 tunnel. The LSP label is a part (20 bits) of the LSP header (32 bits).

At yet a higher level (level of pseudo wires PW), each MPLS tunnel carries one or more pseudo wires (PWs). In our example two PWs exist between nodes PE1 and PE2, so two PW packets (34) with headers PW14 and PW15 (see FIG. 6) are schematically shown above the tunnel packet 32. The PW header (32 bit) incorporates a PW label (20 bit).

It should be kept in mind that each tunnel packet (such as 32) encapsulates only one PW packet 34 of a specific PW. One of the distinctive features of the invention is that packets of the proposed shared tunnel (in our example, the tunnel packets 32) may now intermittently carry packets of different PWs (34), such that source and destination points of these PWs may not coincide with the source and destination point of the tunnel ST. In our simple example, one tunnel packet encapsulates a PW packet of a PW15 which coincides with the tunnel, and a next tunnel packet may encapsulate a PW packet of the PW14—which does not.

The uppermost level of the figure shows a service packet (36) being actually the payload of a packet associated with a specific traffic service which is carried over one or more PWs, in the PW packets.

FIG. 9 illustrates schematically how the proposed sub tunnels, associated with specific pseudo wires PWs, are configured in the proposed network nodes and how that configuration allows processing of packets of different PWs carried over the shared tunnel ST via such a network node. The example of FIG. 9 considers the unidirectional ST1 passing via node PE2.

As has been explained hereinbefore, different pseudo wires which use one and the same ST and share its BW, according to the present invention may have termination points that do not coincide with termination points of the ST. In order to allow that, the present invention allows associating each PW with a specific virtual sub-tunnel within the ST. Each ST tunnel may therefore be seen as comprising several sub-tunnels, each associated with a different {source PE, destination PE} pair along the ST path. This enables a PW extending between a specific {source PE, destination PE} pair of PEs, to be associated with the corresponding sub tunnel (per each direction of the PW).

Therefore, each specific packet of the ST tunnel, depending on its internal PW label, “belongs” to a specific sub-tunnel of the ST tunnel, which sub-tunnel is configured at the NMS and in relevant network nodes (for example, in PE2).

FIG. 9 shows an exemplary, simplified configuration table for a node PE2 of FIG. 6, for one traffic direction (West-East) via the shared tunnel ST1. It goes without saying that the complete configuration table comprises data for the opposite direction of traffic (via the tunnel ST2), and possibly—data about other MPLS tunnels (if any) crossing the node in both directions.

In the table, the first column lists the shared tunnel ST1 and a number of sub-tunnels actual/local for node PE2 (SubT-1, SubT-2, SubT-3). As has already been mentioned, SubT-3 may be absent since it actually repeats the data of ST1 itself. The second column comprises ID numbers of the shared tunnel ST1 and its sub-tunnels (they are all related to ID of ST1). Next columns are the source and destination nodes of the ST1 and its sub-tunnels, as can be noted from FIG. 6. Columns “BW” and “CoS” show that the sub-tunnels inherit these parameters from the ST. The columns “Head”, “Tail”, “Transit” indicate whether a specific tunnel or sub-tunnel starts at, terminates at, or passes through the node PE2.

Whenever the node is configured to have a tail of a sub-tunnel (in our example—it is configured with the Tail of SubT-1), the node is adapted to check all PW labels in the incoming ST1 packets and to perform a DROP (termination) operation for those of them having a PW label indicating that this node is their termination point. It goes without saying that packets incoming through ADD ports should not be checked.

If the node is configured to comprise a head of a sub-tunnel (in FIG. 9 it is the head of sub-tunnel 2), the packets incoming through a preliminarily specified ADD port will acquire, at the node, labels of a PW associated with the sub-tunnel 2. In FIG. 9, sub-tunnel 2 is shown as having no ingress label because PE2 is its Head. The egress label of the ST1 tunnel is appended to service packets added at PE2, and sub-tunnel 2 with destination of PE3 is built for this service at node PE2.

For transit sub-tunnels/tunnel, just cross-connection is required at node PE2, assuming that PW labels are network unique. Otherwise, PW label swapping would be required.

The two “Label” columns of FIG. 9 show the cases in which the Ingress label and the egress label+port of the sub-tunnels are inherited from those of the shared tunnel ST1.

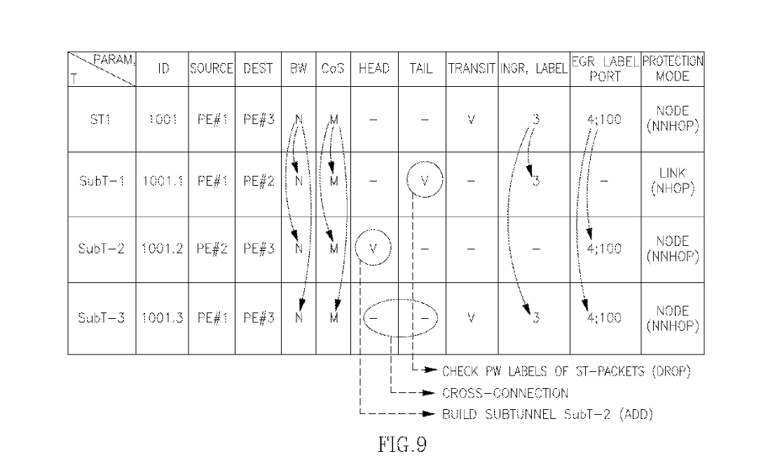

The right-most column of FIG. 9 shows which protection mode (node protection mode i.e., next-next hop NNHop bypass; link protection mode i.e., next hop NHop bypass) is configured at node N2 for the ST tunnel (ST1) and for each of its sub-tunnels. This will be understood with reference to FIG. 7 which illustrates that, according to an embodiment of the invention, the FRR approach of tunnel protection can be applied to the proposed sub-tunnels (and thus makes the protection more economical).

Reverting now to FIG. 6, let us now refer to the tunnel and the PW processing.

In the multi segment PW scheme (MS-PW, FIG. 2), when a tunnel is terminated, the PW label is inspected. When using the inventive scheme of FIG. 6, if any sub-tunnel of the ST which is configured at a node, is terminated at the node (has a tail), the PW labels of all incoming ST packets are inspected. Then Local PWs (those which should be dropped at a specific node) are processed at VSI level (i.e., at Virtual Switching Instance, or PE node level), while the others are PW-switched to pass the node.

Two options for implementation which are presented below show a specific novel process of establishing and processing traffic in the shared ST:

Configuring the ST and sub-tunnels at the management/signaling level: NMS/EMS/signaling configures/“knows” about the shared tunnel and all of its sub-tunnels (ST, ADD DROP, transit, and others).

### Option #1:

1. Configuring ST at the signaling level.

The following explanation is for implementing the method at the level of each specific node along the ST path:

2. Configuring ST and sub-tunnels at each specific node along the ST tunnel. The configuration is carried out at each node management/control plane, and the node configures its own data plane, which is typically done by some HW like a network processor or MPLS switch device. Each specific node is configured/provided with a list of the active sub-tunnels for that node, and each sub tunnel—with indication of its Head or Tail at that node,

a) there is no need to configure sub tunnel which is “transit” with respect to a node—since it has no head nor tail at that node; however, it still may be done at all nodes for the sake of universality of the approach.
b) All sub-tunnels belonging to a specific ST tunnel relate to the ST ID, and at each specific point of the network have the same tunnel label (ST) as the ST tunnel has at the point of the network (note that for a specific tunnel that spans over several nodes, its label is swapped at each node). ST tunnel and its common label for its sub-tunnels means also the common queue for traffic services within the ST tunnel, with applying mechanisms for regulating the queue as accepted for an MPLS tunnel.

3. Associating PWs with sub-tunnels: PWs at each specific node are associated with sub-tunnels configured by signaling, more particularly with heads of sub-tunnels (keeping in mind that prior art solutions allow associating PWs with regular tunnel heads only).

4. Processing of traffic (Data plane at a specific node): Traffic of the shared tunnel ST will be processed at the PW level (by checking PW labels). According to the PW label, the PW will be either switched, i.e. the PW label will be swapped (for transit sub-tunnels which do not have sub-tunnel tail in the node, and if the PW labels are not network-unique) or terminated (for sub-tunnels having their tail associated with the node).

5. Configuring tunnels for tunnel level protection (FRR, DFRR):

a) Provisioning a set of tunnels for protection of the ST tunnel;
b) When FRR protection is activated for the underlined tunnel (such as ST1 or ST2, and for their sub-tunnels in particular), data plane shall swap tunnel labels and PW labels (in PW head or on PW switching) since they are not network unique.

Only for NMS based tunnel and PW static establishment which is performed without using a signaling system (such as MPLS-TP, IETF & ITU initiative, supporting static configuration of tunnels and PWs, as opposed to previous industry common practice that used signaling only), PW labels over sub-tunnels can be synchronized (i.e. to be unique) network-wise. Also, in this case setting two different PW labels for a working tunnel and a protective tunnel is not necessary, and this optimized version is proposed in option #2 below.

### Option#2

1. Configuring ST at the level of NMS.
2. Along the ST tunnel (i.e. from head to tail), each node in the tunnel is configured with a list of the sub-tunnels actual for that node, each sub-tunnel with indication of its Head or Tail at that node (similar to that in Option #1).
   It should be noted that:
   a) Sub-tunnels may, but necessarily be configured at nodes where they are just transit. (Similar to that in Option#1)
   b) All sub-tunnels belonging to a specific tunnel have the same tunnel label.
3. Tunnels and sub-tunnels are set, as defined for option #1 above.
4. PWs are associated with sub-tunnels heads, as defined for option #1 above (it is possible according to the present invention, while it was impossible in the prior art).
5. A PW has a single label along the whole PW path. No PW switching needed. PW labels used for Shared-Tunnels must be unique per the whole MPLS network. This is enforced by the NMS.
6. Data plane: No PW label switching (it is not required because NMS insures that this PW label is not used by other nodes along the PW path).
7. FRR/DFRR protection is done without changing PW label.

If one were to compare these two options, it should have been noted that:

Option #1 is suitable for a signaling based network (option #2 seems less practical for signaling based network because PW label network uniqueness is required).

Option #2 is suitable for NMS managed networks and has the following advantages:
simpler configuration & management; and
better data plane performance (no PW label switching/swapping).

As was mentioned before, the second main purpose of the shared tunnel ST is to ensure protection of MPLS traffic (such as E-tree, E-LAN etc.) at the tunnel level.

FIG. 7 illustrates schematically an embodiment for carrying out this second purpose.

The present invention allows for tunnel protection setup (typically FRR as shown below) to protect the sub tunnels when a fault is detected in the main tunnel path. The protection scheme for the proposed shared tunnel ST may rely on FRR (or on segment tunnel protection, not described herein). Three sub-tunnels for E-tree traffic service are shown by three respective dotted arrows namely 22, 24 and 26, having the common root at node PE1, and different leaves at nodes PE2, PE3 and PE4.

Fig. illustrates a sub-set of the protection tunnel paths (thick rounded arrows 21 and 23) from PE#1, for protecting the ST in case of failure 1 of node NE2, and in case of failure 2 of link between PE1 and PE2. The other nodes and links protection paths (which are members of the full set of protection tunnels) are not presented in this figure.

All traffic (conveyed along sub-tunnels, PWs) which should be conveyed through a point of failure in the ST, will be redirected to the protective tunnel(s), thereby will be protected at the tunnel level.

### Failures' Scenarios

On failure 1, which triggers a node-protection FRR (for example, the PE#2's failure marked as “explosion” 1 in FIG. 7), the PLR (Point of Local Repair, PE#1 in the figure) must perform tunnel label swapping and label push of the FRR tunnel label. It means that the redirected traffic acquires an FRR label and the tunnel label 2 which was normally expected at the merging (Next Next Hop NNH) node PE#3. The node protection FRR tunnel may be referred to as NNH mode of protection (see also FIG. 9).

The FRR “node protection” tunnel (the curved arrow 21) will be used by the traffic of PWs associated with sub-tunnels 24 and 26.

On failure 2 (see for example “explosion” 2 on the link between PE1 and PE2 of FIG. 7), the PLR triggers a link-protection FRR, and tunnel 23 is established, which is a of Next Hop (NH) mode of protection. The redirected traffic acquires an FRR label and the tunnel label 1 which is expected at the NH node PE#2. The FRR “link protection” tunnel 23 will be used by the traffic of the PW associated with the sub-tunnel 22.

One can see that the protection of E-TREE (E-LAN) MPLS traffic can be performed at the tunnel level, and per sub-tunnel of the shared tunnel ST. The invention allows applying the known FRR technique to sub-tunnels, rather than to tunnels.

Pseudo wires carry the PW labels which they should normally obtain, irrespective of whether they use a working tunnel/sub tunnel, or a protection tunnel. In case PWs are network-unique, PW swapping would not be needed.

Still, there might be a problem that, having the illustrated link level and node level bypass tunnels, and in case of failure detected at PE#1, it would be necessary to decide whether to perform a link level or a node level protection, although typically PE#1 cannot distinguish between link failure and node failure.

The Applicant's technique of dual FRR (DFFR), described in US 2011/0110224, can be successfully applied to solve the above problem, and to ensure tunnel level protection for the shared tunnel ST. Alternatively, the protection may be split per sub-tunnels of the ST: the sub-tunnel traffic (22) destined to PE#2 will get link protection bypass, while all other traffic flows (24, 26) will get the node protection bypass.

It should be appreciated that while the invention has been described with reference to specific examples and drawings, other versions of the method may be proposed which should be considered part of the invention whenever defined by the claims which follow.

1. A method for providing an MPLS tunnel for sharing bandwidth (BW) in an MPLS network, the method comprises establishing said MPLS tunnel as a working MPLS tunnel (ST) common for a plurality of pseudo wires (PWs) passing at least partially along the tunnel ST path, wherein a predetermined bandwidth of the bandwidth allocated for the ST is adapted to be shared by said plurality of PWs of which at least one PW has a different source point and/or a different destination termination point at said ST path, from at least one other of the plurality of PWs.

2. The method according to claim 1, further comprising provisioning of at least one sub-tunnel within said ST, and associating one or more of said plurality of PWs with a specific sub-tunnel out of said sub-tunnels; said specific sub-tunnel having the same source and destination points as its associated one or more PWs, but different from the source and/or destination points of the ST, and utilizing at least a label associated with the ST and at least partially the bandwidth BW allocated for the ST.

3. The method according to claim 1, further comprising provisioning more than one of said sub-tunnels and associating some of said plurality of PWs with said sub-tunnels and some of said plurality of PWs with said ST.

4. The method according to claim 1, wherein said plurality of PWs is provided for E-TREE and/or E-LAN traffic services.

5. The method according to claim 1, which comprises:
provisioning said working MPLS tunnel ST, having an ST Tunnel ID and a predetermined bandwidth BW allocated therefore, having a path extending between a source node and a destination node via an intermediate node within the MPLS network (ST path), and wherein traffic of said ST carries a specific ST label at each specific point of said path extending between the source node and the destination node;
provisioning said plurality of pseudo wires (PWs) for P2MP or MP2MP traffic services within said ST, so that at least one of said plurality of PWs is either started or terminated at said Intermediate node of the ST;
for said plurality of PWs, provisioning one or more sub-tunnels within said ST and associating said sub-tunnels with said PWs, so that each of the sub-tunnels has the same source and destination points as its associated one or more PWs, wherein at each specific point of the ST path the sub-tunnels inheriting parameters of the ST, wherein the inherited parameters include at least the label and the BW of said ST;
providing traffic services over the provisioned plurality of PWs within the MPLS tunnel ST, thereby allowing said traffic services conveyed along the PWs to share the predetermined BW of the ST.

6. The method according to claim 1, further comprising a step of protecting traffic being carried over the working MPLS tunnel ST in case of a failure of an element or link along a path extending between a source node and a destination node via an intermediate node within the MPLS network (ST path), by provisioning a set of bypass MPLS tunnels for said working MPLS tunnel ST.

7. The method according to claim 2, comprising the following steps:
at a managing entity:
configuring the ST and said sub-tunnels within the ST for the plurality of PWs, and associating said plurality of PWs with said configured sub-tunnels;
configuring one or more tunnels in the MPLS networks for tunnel level protection of said ST;
at each intermediate node (PE) along the ST path:
configuring said ST, and said sub-tunnels at the node, by providing at said intermediate node a list of the sub-tunnels relevant for said intermediate node, and each of said sub-tunnels with an indication regarding presence of its head or tail at that intermediate node;
processing traffic services carried by the ST tunnel, so as in case that:
for any of the sub-tunnels having a tail at the intermediate node, performing a check of PW labels and further terminating traffic of the PW having its destination point at said intermediate node; for any of the sub-tunnels having a head at the intermediate node, allowing egress from the intermediate node of a new PW having its source point at said intermediate node;
for a sub-tunnel having no tail nor head at said intermediate node, performing at least cross-connection in the intermediate node of the PW associated with said sub-tunnel.

8. The method according to claim 2, comprising synchronizing use of the plurality of PWs in the network so as to utilize a single unique label for each specific PW in the network.

9. A management entity configured to operate in an MPLS network, adapted for providing an MPLS tunnel for sharing BW in the MPLS network, the management entity being capable of establishing said tunnel as a common MPLS working tunnel (shared tunnel ST) for a plurality of pseudo wires (PWs) along the tunnel ST path in said network, wherein a predetermined BW of the bandwidth allocated for the ST is configured to be adapted to be shared by said plurality of PWs of which at least one PW has a different source point and/or a different destination termination point at said ST path, from at least one other of the plurality of PWs.

10. A network node configured to support an MPLS working shared tunnel (ST) carrying traffic packets, said ST is established by a network managing entity operative in an MPLS network for more than one pseudo wires (PWs) commonly utilizing the tunnel ST path in said network and sharing a predetermined bandwidth (BW) allocated to the ST; the MPLS network node being part of said ST path and being configured to ensure, for one or more of said PWs having source and/or destination/termination points which do not coincide with the source and/or destination points of the ST, with suitable processing of the traffic packets.

11. A non-transitory computer readable medium storing a computer program for executing a set of instructions by a computer system comprising one or more computer processors a process for providing an MPLS tunnel adapted to allow bandwidth BW sharing in an MPLS network in accordance with the method claimed in claim 1.
